(19) United States
(12) Patent Application Publication
(10) Pub. No.: US 2023/0244697 A1
(43) Pub. Date: Aug. 3, 2023

(54) SYSTEMS AND METHODS FOR HYBRID RECORD UNIFICATION USING A COMBINATION OF DETERMINISTIC, PROBABILISTIC, AND POSSIBILISTIC OPERATIONS

(71) Applicant: Verizon Patent and Licensing Inc., Basking Ridge, NJ (US)

(72) Inventor: Pratik K. Biswas, Morganville, NJ (US)

(73) Assignee: Verizon Patent and Licensing Inc., Basking Ridge, NJ (US)

(21) Appl. No.: 17/588,472

(22) Filed: Jan. 31, 2022

(51) Int. Cl. G06F 16/28; G06F 16/2458; G06F 16/248

(52) U.S. Cl. CPC G06F 16/285; G06F 16/2468; G06F 16/248

(57) ABSTRACT

A hybrid linkage system may receive data records from different data sources, and may merge data records from the data sources with or without crisp or fuzzy constraints. The system may compute scores based on fuzzy match results between different data fields from a first data record and a second data record of a merged data record pair. The system may classify the merged data record pair with a weight from the first linguistic term based on the relative importance of the first fuzzy match score, and with a weight from the second linguistic term based on the relative importance of the second fuzzy match score, and may execute an action that uses consolidated data from the first and second data records in response to the first linguistic term and the second linguistic term evaluating to a match between the first data record and the second data record.

### BACKGROUND

Data about a particular subject or entity may be segregated across different data sources. The data may be segregated due to independent operation and/or usage of each data source by different teams, processes, and/or applications. Misspellings, typographical errors, changing values, missing values, and/or other variations may also occur in the data relating to the same subject or entity in the different data sources. The segregation and variance in the data stored in the different data sources may reduce operational effectiveness because actions targeting the particular subject or entity may be performed using less than all the data that is available on the particular subject or entity.

### BRIEF DESCRIPTION OF THE DRAWINGS

FIG. 1 illustrates an example of a hybrid linkage system that customizes content recommendations based on consolidated data that is generated from disparate data sources using the hybrid linkage in accordance with some embodiments presented herein;

FIG. 2 illustrates an example of the hybrid linkage system adjusting network parameters based on consolidated data generated from a hybrid linkage of data records from disparate data sources in accordance with some embodiments presented herein;

FIG. 3 illustrates an example of the hybrid linkage system functioning as a unified database that generates consolidated data based on a hybrid linkage of data records from different data sources in accordance with some embodiments presented herein;

FIG. 4 presents an example of a hybrid linkage definition in accordance with some embodiments presented herein;

FIG. 5 presents a process for performing the hybrid record linkage in accordance with some embodiments presented herein;

FIG. 6 illustrates an example of constraining the search space of input data sets retrieved from two different data sets based on a specified constraint in accordance with some embodiments presented herein;

FIG. 7 illustrates an example environment in which one or more embodiments, described herein, may be implemented;

FIG. 8 illustrates an example arrangement of a radio access network (“RAN”), in accordance with some embodiments; and

FIG. 9 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide systems and methods for performing a hybrid linkage of data records in different data sources based on a set of hybrid operations. The hybrid linkage and/or the set of hybrid operations may facilitate the combination and/or simultaneous use of deterministic, approximate, probabilistic, possibilistic, and/or other techniques to generate true and/or fuzzy (e.g., possible) matches between the data records of the different data sources. Consolidated data from the matching data records may be returned in response to a single search query even though data from one or more of the data records matched via the hybrid linkage may not match or satisfy the search query and may not be returned as a search result if searched without the hybrid linkage. The consolidated data may provide a comprehensive state for a particular subject or entity despite the state information being segregated across data sources and/or being stored with differing identifiers and/or values (e.g., misspellings, typographical errors, changing values, missing values, etc.).

The systems and methods may implement automated actions and/or control actions that target the particular subject or entity based on the resulting consolidated data. In some embodiments, the actions may include customizing content for the targeted subject, and presenting, outputting, etc. such customized content to the targeted entity. In some embodiments, the actions may include improving network service by dynamically adjusting network parameters based on preferences, past behaviors, usage statistics, and/or other insights that are consolidated within the linked data records and that are otherwise segregated in different data sources.

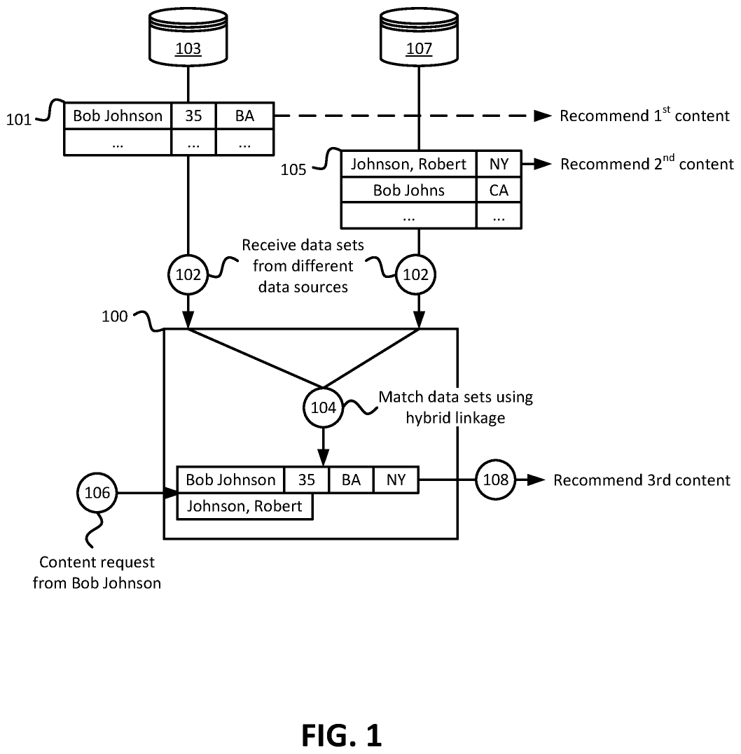

FIG. 1 illustrates an example of a hybrid linkage system that customizes content recommendations based on consolidated data that is generated from disparate data sources using the hybrid linkage in accordance with some embodiments presented herein. FIG. 1 illustrates hybrid linkage system 100 receiving (at 102) a first set of data records 101 from first data source 103, and a second set of data records 105 from second data source 107.

Data records 101 and 105 may include database records, spreadsheets, comma delimited files, tables, files with structured data, and/or other files with two or more fields or columns containing data for different subjects or entities. Data records 101 and 105 may be segregated as a result of different teams, processes, and/or applications collecting and/or entering data to the different data sources (e.g., first data source 103 and second data source 107).

As shown in FIG. 1, the first set of data records 101 may include demographics, such as age, education level, etc. of a particular entity and at least a first identifier used in identifying the particular entity, and the second set of data records 105 may include location information of the particular entity and at least a second identifier used in identifying the particular entity. The first and second identifiers may be the same or may differ intentionally or unintentionally. For instance, the first and second identifiers may differ as a result of a typographical error, misspelling, and/or other incorrect entry of data. Alternatively, the first and second identifiers may differ as a result of an abbreviation being used for one but not the other identifier, different formatting, different acceptable values, and/or other different values that may be used to represent the same data. In this example, the first set of records 101 includes a record with “Bob Johnson” as an identifier, and the second set of records 105 includes respective records with “Johnson, Robert” and “Bob Johns” as identifiers.

The data within the first set of data records 101 and the data within the second set of data records 105 may each provide an incomplete representation of the data that is collected on the particular entity by an enterprise or organization since that data is distributed and/or segregated across data sources 103 and 107. Consequently, the data within the first set of data records 101 may satisfy first criteria for recommending and/or presenting a first content item to the particular entity, and the data within the second set of data records 105 may satisfy second criteria for recommending and/or presenting a different second content item to the particular entity. For instance, the age and the education level of the particular entity captured in the first set of data records 101 may match to models that are generated from entities with a similar age and education level and that purchased or showed a preference for a first product. The location of the particular entity captured in the second set of data records 105 may match to models that are generated from entities in a similar location and that purchased or showed a preferences for a second product.

Rather than generate the recommended content based on the segregated data records from a single data source 103 or 107, hybrid linkage system 100 may perform (at 104) a hybrid linkage to detect matches between different data records of the first set of data records 101 from first data source 103 and the second set of data records 105 from second data source 107. Performing (at 104) the hybrid linkage may include using a combination of deterministic, probabilistic, possibilistic, and/or other techniques to determine exact matches and also possible or fuzzy matches between the first set of data records 101 and the second set of data records 105. For instance, hybrid linkage system 100 may determine exact matches between a first data field or column of a first data record from first data source 103 and a second data record from second data source 107, may determine approximate matches between a second data field or column of the first and second data records, and may use fuzzy set operations to determine if the exact and approximate matches are sufficient to establish a true or possible link between other data contained in the first and second data records. In some embodiments, hybrid linkage system 100 may use a combination of fuzzy matching, fuzzy set theory, fuzzy logic, fuzzy constraints, fuzzy weights, fuzzy rule-based interfering, fuzzy clustering, and/or other fuzzy set operations to generate the possibilistic linkages. The hybrid linkage may consolidate data from data records that are a true or possible (e.g., fuzzy) match for the particular entity.

As shown in FIG. 1, the hybrid linkage may generate a match and/or consolidate the data between the data record with the entity identifier of “Bob Johnson” from the first set of data records 101 and the data record with the entity identifier of “Johnson, Robert” from the second set of data records 105. A deterministic linkage may yield no matches between the first set of data records 101 and the second set of data records 105, as a result of no exact matching of entity identifiers between the first set of data records 101 and the second set of data records 105 (e.g., “Bob Johnson” is not an exact match with “Johnson, Robert”). Moreover, a pure probabilistic linkage may yield a false match with high probability between data records from the first second set of data records 101 and the second set of data records 105 with the entity identifiers “Bob Johnson” and “Bob Johns” because these two data records require fewer transformations to match than the data records with the entity identifiers “Bob Johnson” and “Johnson, Robert”. However, a possibilistic linkage may produce more accurate matches between the entity identifiers of data records 101 and 105 (e.g., correctly identify a match between the data record with the entity identifier of “Bob Johnson” from the first set of data records 101 and the data record with the entity identifier of “Johnson, Robert” from the second set of data records 105), and may be selected, in place of or to supplement the deterministic and/or pure probabilistic linkages, to determine matches between the entity identifiers of data records 101 and 105.

In some embodiments, hybrid linkage system 100 may store the results of the hybrid linkage in cache, local storage, or another data source (e.g., data source 103 or 107), and search queries and/or content requests intended for data sources 103 and 107 may be directed to hybrid linkage system 100. Consequently, a single search query may be run against the consolidated data set generated by hybrid linkage system 100 instead of being run separately against each data source 103 and 107. The search may return consolidated data from a data record pair that was matched using the hybrid linkage, whereas the separate searching of data source 103 and 107 may fail to retrieve the data from a first data record of the data record pair when the search query matches to the data from a second data record of the data record pair.

For instance, hybrid linkage system 100 may receive (at 106) a content request for data about the particular entity alternatively identified as “Bob Johnson” and “Johnson, Robert”. In some embodiments, the content request may be issued after a login is performed that accesses a profile or account of “Bob Johnson”. In some embodiments, the content request may include a query with one of the “Bob Johnson” and “Johnson, Robert” entity identifiers.

In response to the content request, hybrid linkage system 100 may obtain the consolidated data for the particular entity generated via the hybrid linkage, and may recommend and/or present (at 108) a third content item to the particular entity based on the consolidated data. For instance, the first content item may correspond to a first product that is determined to be most popular among users in the age range and education level of the particular entity, the second content item may correspond to a second product that is determined to be most popular among users in the same location as the particular entity, and the third content item may correspond to a third product that is determined to be most popular among users in the same age range, education level, and location as the particular entity (e.g., determined based on a combination of features, attributes, associated with different data sources and/or sets of data records).

In some embodiments, hybrid linkage system 100 may operate as a search engine, and may return the consolidated data of two or more data records that match or satisfy a search query. In doing so, hybrid linkage system 100 may supplement search engine results by providing data from a first data record that matches the search query, and also data from a second data record that may not match the search query but that provides supplemental or related data to the first data record as a result of a hybrid linkage established between the first data record and the second data record. Without the hybrid linkage, the data from the second data record may not appear in search engine results, or may appear further down in the results and apart from the data of the first data record.

Accordingly, hybrid linkage system 100 may use the possibilistic matches resulting from the hybrid linkage to supplement deterministic linkages and/or to invalidate false probabilistic linkages. Moreover, hybrid linkage system 100 may use the consolidated data from the possibilistic matches to identify a comprehensive state for a particular subject or entity across the different data sources 103 and 107, and to generate actions that target the particular subject or entity based on the comprehensive state.

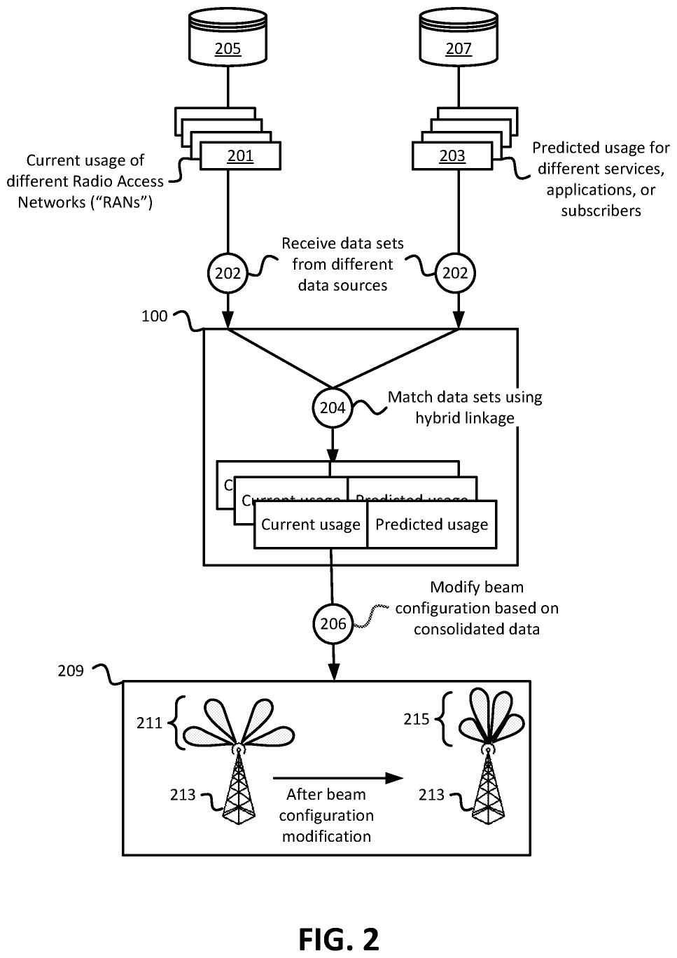

FIG. 2 illustrates an example of hybrid linkage system 100 adjusting network parameters based on consolidated data generated from a hybrid linkage of data records from disparate data sources in accordance with some embodiments presented herein. As shown in FIG. 2, hybrid linkage system 100 may receive (at 202) data records 201 and 203 from first data source 205 and second data source 207 respectively. The data records from each data source 205 and 207 may contain different data for one or more Radio Access Networks (“RANs”) that provide wireless coverage in different geographic areas. For instance, first data source 205 may store usage data models, resource data models, subscriber data models, location-based models, and/or other data models indicating available and/or used Radio Frequency (“RF”) resources associated with one or more base stations (e.g., Next Generation Node Bs (“gNBs”), evolved Node Bs (“eNBs”), and/or types of base stations) that provide wireless coverage in a geographic area, a quantity of user equipment (“UEs”) connected to respective base stations, performance and/or Quality of Service (“QoS”) metrics associated with respective base stations (e.g., throughput, latency, jitter, indications of whether QoS thresholds are met, or the like), and/or other indications of network slices used by the UEs (e.g., where a “slice” refers to an instance of a network in which multiple instances are implemented or available). Second data source 207 may store historical usage information associated with different services, applications, and/or subscribers.

Hybrid linkage system 100 may perform (at 204) a hybrid linkage of the received data. The hybrid linkage may identify matches between data records from the different data sources 205 and 207 based deterministic, probabilistic, and/or possibilistic (e.g., fuzzy) linkages established between different data fields and/or columns of the data records. For instance, deterministic techniques may be used to determine if data in a first data field from the data records of data sources 205 and 207 are an exact match, probabilistic techniques may be used to determine if data in a second data field from the data records are approximate matches that match by a threshold probability, and possibilistic techniques may be used to determine if data in a third data field from the data records are possible matches according to fuzzy set operations (e.g., fuzzy matching, fuzzy set theory, fuzzy logic, fuzzy constraints, fuzzy weights, fuzzy rule-based interfering, fuzzy clustering, etc.). Hybrid linkage system 100 may merge data records from first data source 205 and second data source 207 based on matches established on one or more of the data fields using one or more of the deterministic, probabilistic, and/or possibilistic techniques, wherein the hybrid linkage may identify data records that contain current usage of RAN 209 resources by different UEs, and expected or possible future usage associated with the services, applications, and/or subscribers associated with the different UEs. Hybrid linkage system 100 may determine matches between data records from data sources 205 and 207 that identify the services or applications with different identifiers (e.g., Uniform Resource Locators (“URLs”) or paths of different lengths or formats, different names, etc.), or between data records from data sources 205 and 207 that identify a subscriber associated with a UE using a first identifier (e.g., “Robert Johnson”) and that identify the expected usage or historical usage of the same subscriber with a second identifier (e.g., “Johnson, Bob”).

Hybrid linkage system 100 may perform a single search of the consolidated data to obtain a comprehensive account of current resource usage at RAN 209 from the data records of first data source 205, and expected future usage based on the services, applications, and/or subscribers that relate to the current usage from the data records of the second data source 207. Separate searching of data sources 205 and 207 may return expected or possible future usage that is not matched to, disassociated from, or incorrectly matched to the current usage at RAN 209.

Hybrid linkage system 100 use the consolidated data returned in response to the search to optimize network service for UEs accessing services via RAN 209. Optimizing the network service may include adjusting (at 206) network parameters of RAN 209 based on the consolidated current and expected usage determined for RAN 209. For instance, hybrid linkage system 100 may modify directionality, beam width, antenna power, and/or other aspects for first beam configuration 211 of base station 213 in RAN 209, resulting in base station 213 operating with a modified second beam configuration 215. Modified second beam configuration 215 may provide additional RF resources such that the coverage area associated with base station 213 is more focused to the locations of current and expected usage.

In some embodiments, hybrid linkage system 100 may provide a unified database that consolidates and presents matched data from one or more data sources in response to a single query issued to hybrid linkage system 100. In some such embodiments, the unified database may use the true and fuzzy or possible matches resulting from the hybrid linkage to identify record linkages that are different than and/or that may be used to supplement or verify record linkages determined from deterministic and/or probabilistic techniques. In this manner, the hybrid linkage may provide an increased number of true and possible matches and a decreased number of false matches relative to data consolidation resulting from deterministic linkages or probabilistic linkages.

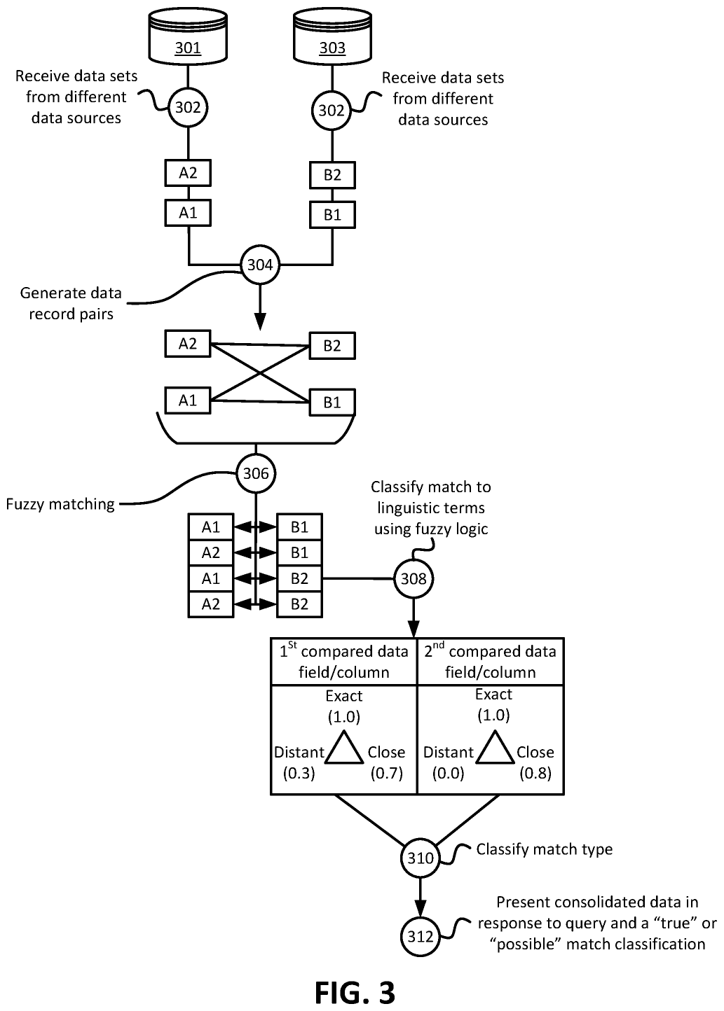

FIG. 3 illustrates an example of hybrid linkage system 100 functioning as a unified database that generates consolidated data based on a hybrid linkage of data records from different data sources in accordance with some embodiments presented herein. As shown in FIG. 3, hybrid linkage system 100 may receive (at 302) data records from one or more data sources 301 and 303, and may generate (at 304) different data record pairs or combinations for evaluation. In some embodiments, the pairing of data records may be constrained or the resulting pairs may be filtered to eliminate data record pairs that do not satisfy one or more constraints from evaluation or matching consideration. In some embodiments, the data record pairs may include data records from the same data source (e.g., data source 301 or data source 303) that are paired together for evaluation. In some embodiments, the data record pairs may include data records from different data sources 301 and 303 that are paired together for evaluation.

Misspellings, typographical errors, changing values, missing values, and/or other variations in the data records may result in a low number of exact or deterministic matches being made between different pairs of data records when performing a deterministic linkage. Conversely, probabilistic linkage may not properly account for the misspellings, typographical errors, changing values, missing values, and/or other variations in the data records from first data source 301 and the data records from second data source 303, and may identify either several false matches or false mis-matches depending on the cut-off probability threshold used in evaluating the probabilistic linkages.

Instead, hybrid linkage system 100 may perform (at 306) a fuzzy or approximate matching between each pair of data records to generate scores that quantify the similarity between data of a data record pair. Hybrid linkage system 100 may use (at 308) fuzzy logic to classify the scores into linguistic terms or fuzzy sets represented by linguistic terms. For instance, the fuzzy sets may be represented by the terms “distant”, “close”, and “exact”, and the fuzzy logic may generate a fuzzy number or triangular fuzzy number to represent the degree with which the scores satisfy membership in one or more of the fuzzy sets. In some embodiments, the fuzzy number may include a connected set of possible values that range from 0 to 1, and a triangular fuzzy number may be represented as a triplet (m1, m2, m3), where “m1” represents a smallest likely value, “m2” the most probable value, and “m3” the largest possible value for membership within a fuzzy set or association with a linguistic variable. In some embodiments, hybrid linkage system 100 may compute a total linkage score for each linguistic variable based on the fuzzy numbers resulting from each compared data field or column.

Hybrid linkage system may classify (at 310) the match result based on a fuzzy clustering of the linkage scores derived for each compared data field or column of the data record pair, and may present (at 312) the consolidated data from the data record pair in response to a query that implicates data in one or more of the data record pair and in response to the data record pair being classified as a true match or a possible match. In some embodiments, the consolidated data output from the unified database may be used to improve patient diagnosis and/or treatments. For instance, the consolidated data may not identify a true match to any particular condition. However, the consolidated data may yield possible matches for one or more conditions that a physician may then evaluate in diagnosing a patient. Similarly, hybrid linkage system 100 may generate a treatment plan for a patient based on the possible matches detected via the hybrid linkage.

In some embodiments, hybrid linkage system may use the classification/categorization from the hybrid linkage to supplement or verify record linkages determined from deterministic and/or probabilistic linkages. For instance, a match of a particular data record pair determined from a probabilistic linkage may be invalidated if the same particular data record pair is not determined to be a true match or a possible match on the same or different data fields of the particular data record pair with the hybrid linkage. The hybrid linkage may be used in conjunction with deterministic and/or probabilistic linkages to better diagnose the condition of a patient and/or to provide a safe and effective treatment plan based on comprehensive data that is compiled for that patient in different data sources and that is presented in as consolidated data by the unified database in response to a single query.

In some embodiments, the hybrid linkage may be customized and/or controlled by a hybrid linkage definition. The hybrid linkage definition may include a file, input data, and/or instructions for configuring hybrid linkage system 100 to perform different deterministic, probabilistic, possibilistic, and/or other linkage on different data fields or columns, and/or to use different deterministic, probabilistic, and/or fuzzy set operations to classify the linkage results. For instance, the fuzzy set operation may define different weights to increase or decrease the importance for different fuzzy sets or linguistic variables used for the match classification.

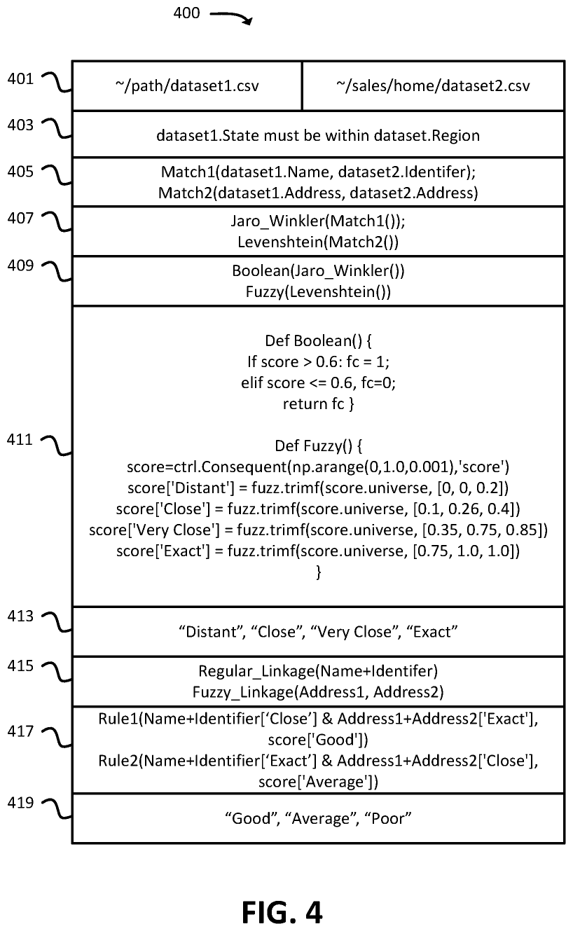

FIG. 4 presents an example of a hybrid linkage definition 400 in accordance with some embodiments presented herein. Hybrid linkage definition 400 may include one or more of input data set identifiers 401, search space constraints 403, data field or column selector 405, matching algorithm selector 407, logic type identifier 409, thresholds 411, linguistic terms 413, linkage type identifier 415, fuzzy rules 417, and fuzzy cluster definitions 419. In some embodiments, hybrid linkage definition 400 may include more or less parameters for configuring and/or controlling the hybrid linkage performed by hybrid linkage system 100.

Input data set identifiers 401 may include URLs, paths, and/or other links for accessing different input data sets or data records from different data sources that to be evaluated using the hybrid linkage. The targeted input data sets or data records may be stored in tables, databases, data structures, and/or other files of the different data sources.

Search space constraints 403 may include constraints that limit the merging of the input data sets or data records from the different data sources. Search space constraints 403 may be defined as exact or fuzzy constraints.

Exact constraints may include specific values that control the pairing of the different data sets. For instance, an exact constraint may pair data records from a first data source that have a first specific value with data records from the second data source that have a second specific value.

Fuzzy constraints may include a range, approximate values, related values, and/or other values with some defined relation. In some embodiments, a fuzzy constraint may be satisfied based on a degree of satisfaction rather than a Boolean yes or no. Search space constraints 403 may therefore serve to reduce the total number of comparisons that hybrid linkage system 100 performs based on prior knowledge that matches do not exist for certain pairs of data records.

Data field or column selector 405 may specify the specific fields or columns within the data records that are subject to matching. For instance, a first set of data records from a first data source may include the fields or columns of first name, last name, age, income, address, and occupation, and a second set of data records from a second data source may include fields or columns of entity identifier, address, past purchases, and education level. Data field or column selector 405 may specify comparing the name and address of the first set of data records against the entity identifier and address of the second set of data records to determine if a hybrid linkage or match can be established between different pairings of the first set of data records and the second set of data records.

Matching algorithm selector 407 may customize the matching that is performed on each of the data fields or columns identified in the data field or column selectors 405. Values for matching algorithm selector 407 may include exact matching, fuzzy matching, and/or other matching techniques. When exact matching is specified for a first data field or column, hybrid linkage system 100 may compare the first data field or column for a data record pair to determine if the values specified in that pair are identical matches. When fuzzy matching is specified for a second data field or column, hybrid linkage system 100 may perform an approximate string matching on the second data field of column of a data record pair. The match score for the fuzzy matching may be a value that quantifies the amount of similarity or dissimilarity between the compared data fields. For instance, the closeness of a match may be quantified as an edit distance. The edit distance may be measured in terms of the number of operations necessary to convert the string from one data record to match the string of another data record. For instance, the edit distance or match score for a fuzzy match of the strings “Bob Jones” and “Bob Jone” may be 1, and the edit distance or match score for a fuzzy match of the strings “Bob Jones” and “Bobby Jones” may be 2. Different techniques may be used to compute the edit distance. In some embodiments, matching algorithm selector 407 may support one or more of Levenshtein, Jaro-Winkler, Jaccard, Needleman Wunsch, Trigram, and other fuzzy matching techniques.

Logic type identifier 409 may specify the technique for evaluating the match results. Logic type identifier 409 may support Boolean, fuzzy, and/or other values.

A Boolean logic type identifier 409 may specify evaluating the match results to either a true or false value. The Boolean logic type identifier 409 may be conditioned on thresholds 411. For instance, a fuzzy match with a value greater than 0.6 may be evaluated as a true match (e.g., a value of 1) when logic type identifier 409 is set to Boolean for that fuzzy match and thresholds at 411 for that fuzzy match specify a true match score of 1 for fuzzy match results with values greater than 0.6. Similarly, a fuzzy match with a value of 0.6 may be evaluated as a false match (e.g., a value of 0) when logic type identifier 409 is set to Boolean for that fuzzy match and thresholds at 411 for that fuzzy match specify a true match for fuzzy match results with values greater than 0.6.

The fuzzy logic type identifier 409 may configure hybrid linkage system 100 to use fuzzy logic to classify the match scores to one or more linguistic terms 413 using thresholds 411. Linguistic terms 413 may be used to define a fuzzy value scale that includes non-numeric values for expressing facts and/or rules. Linguistic terms 413 may include words representing different fuzzy sets for classifying different degrees of linkage between a data record pair. For instance, the terms “exact”, “very close”, “close”, and “distant” may be linguistic terms 413 for classifying different degrees of linkage. Thresholds 411 may be defined with overlapping ranges or values in order to classify the match scores to one or more linguistic terms 413.

A Fuzzy Analytic Hierarchy Process (“FAHP”) may be used to compute and/or assign weights from the linguistic terms describing the relative importance of the data fields or columns. The weights may include fuzzy weights that may be represented as triangular fuzzy numbers. In some embodiments, the FAHP may use the geometric mean method, extent analysis method, and/or the entropy-based method to compute and/or assign the fuzzy weights to the linguistic terms based on their relevance to the overall linkage. In some embodiments, the fuzzy weights may be defuzzified and assigned to the respective data fields or columns of interest. In some embodiments, the weights assigned to the linked data fields in a record pair may be default or probabilistic values.

Linkage type identifier 415 may determine the operations for computing a total linkage score for a data record pair based on the matching scores, weights assigned to linguistic terms 413, and/or other values resulting from the matching evaluation. Computing a total linkage score based on a “regular” linkage type identifier 415 may include converting the assigned weights to crisp weights via one or more defuzzification techniques, and computing a total linkage score from the dot product of the match scores and crisp weights derived for each data field or column of a data record pair. Computing a total linkage score based on a “fuzzy” linkage type identifier 415 may include extracting the a-cuts from the triangular fuzzy numbers representing the fuzzy weights and the score ranges (e.g., intervals with medians) of the linked data fields or columns. The fuzzy aggregation may include generating weighted match scores for the linked data fields or columns using their defuzzified weights and match scores, and generating a fuzzy weighted average of the a-cuts of fuzzy weights and the fuzzy scores, subsequently representing the result as a triangular fuzzy number. Fuzzy sets for the linguistic terms may then be defined using sub-intervals from the spread (e.g., range) and distribution of the weighted match scores of the respective linked columns as well as the computed interval for the total linkage score.

Fuzzy rules 417 may be used to adjust the weighting or importance of different match scores in the overall total linkage score. In particular, fuzzy rules 417 may be used to adjust the weighting attributed to each of the fuzzy sets, thereby increasing or decreasing the importance of different fuzzy sets produced from evaluating the match results of different data fields or columns. For instance, fuzzy rules 417 may specify that a “close” classification for a first data field and an “exact” classification for a second data field may result in a first total linkage score, whereas the “exact” classification for the first data field and the “close” classification for the second data field may result in a different second total linkage score. More specifically, fuzzy rules 417 may give greater importance to match results on first name and last name data fields than to an address data field in the computation of the total linkage score. Fuzzy clustering techniques may use the total linkage score to define membership of the data record pairs to a number of clusters specified in fuzzy cluster definitions 419.

Hybrid linkage definition 400 may configure hybrid linkage system 100 to implement purely deterministic linkages by specifying exact string matching, Boolean logic, and regular linkage with a default weight of 1 for each linked data field or column, and by computing the total linkage score for each data record pair as the sum of the match scores of linked data fields or columns. Similarly, hybrid linkage definition 400 may configure hybrid linkage system 100 to implement purely probabilistic linkages by specifying approximate string matching, Boolean logic, and regular linkage, by computing either a simple or complex probabilistic weight vector for the linked data fields or columns, then by computing the total linkage score for each data record pair as the dot product of the probabilistic weight vector and the approximate match scores. Moreover, hybrid linkage definition 400 may configure hybrid linkage system 100 to implement possibilistic linkages via a combination of deterministic and fuzzy set operations. For instance, exact and fuzzy matching and Boolean and fuzzy logic may be selected for different data fields or columns, and regular and/or fuzzy linkages may be defined to compute a total linkage score from linguistic terms, fuzzy weights (e.g., fuzzy numbers), and matching scores. Fuzzy clustering may then be used to determine a degree with which data records from merged data record pairs match, and for classifying the pairs as true, possible, no, and/or other types of matches.

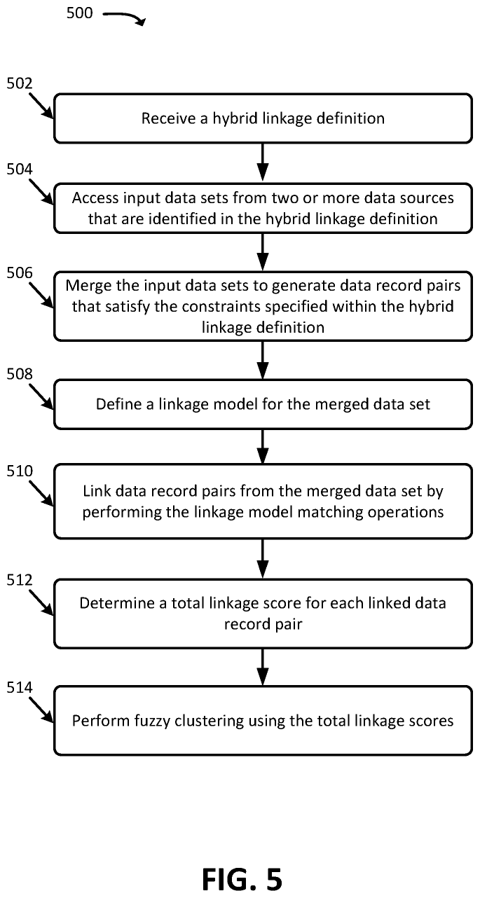

FIG. 5 presents a process 500 for performing the hybrid record linkage in accordance with some embodiments presented herein. Process 500 may be implemented by hybrid linkage system 100, a recommendation engine that outputs customized content based on consolidated data that is linked from different data sources using the hybrid record linkage, a network controller that adjusts network parameters based on consolidated data from different data sources that is linked using the hybrid record linkage, a unified database that responds to a query using consolidated data from different data sources that is linked using the hybrid record linkage, and/or other systems or devices that leverage data from multiple data sources for various tasks and/or operations.

Process 500 may include receiving (at 502) a hybrid linkage definition to configure and/or control the hybrid linkage. The hybrid linkage definition may include some or all of the parameters described above with reference to FIG. 4, and may be used to customize the matching and matching evaluation that is performed on data sets from different data sources.

Process 500 may include accessing (at 504) input data sets from two or more data sources that are identified in the hybrid linkage definition (e.g., input data set identifiers 401). The data sources may include databases, data repositories, data structures, storage mediums or devices, and/or files. Hybrid linkage system 100 may copy, download, or otherwise retrieve the data sets from the different data sources.

Process 500 may include merging (at 506) the input data sets to generate data record pairs that satisfy any constraints specified within the hybrid linkage definition. The merging (at 506) may produce a constrained search space from which links between data record pairs may be established.

In some embodiments, the merging (at 506) may include constraining the search space using blocking with either exact or fuzzy constraints defined through exact or fuzzy neighborhoods. Blocking may reduce the comparison space by applying the constraints to specific data fields or columns. In other words, data record pairs may be formed when certain data fields or columns within the pairs satisfy the specified constraints. Other data fields or columns may be ignored and not used in determining whether to pair data records from different data sources.

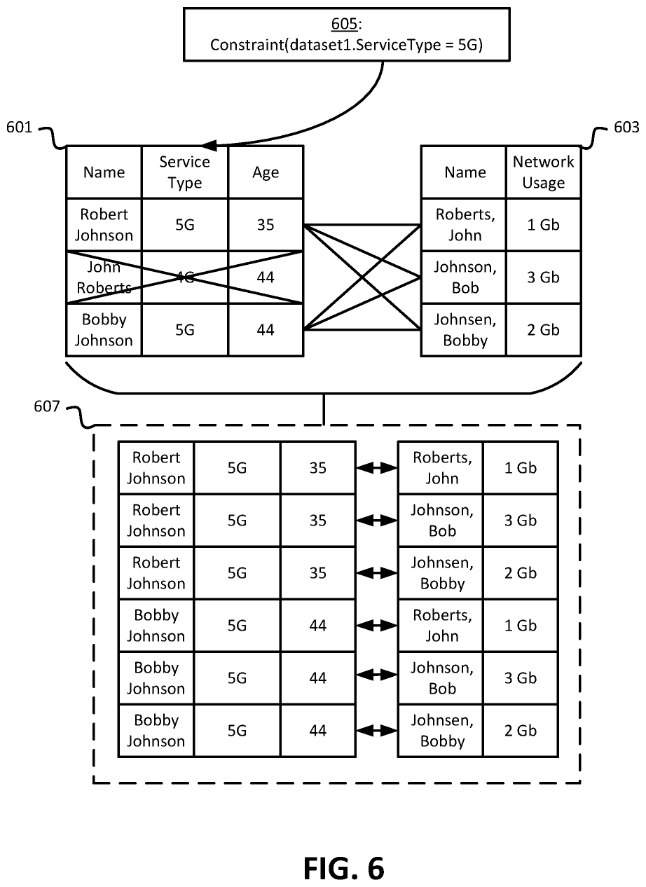

FIG. 6 illustrates an example of constraining the search space of input data sets retrieved from two different data sets based on a specified constraint in accordance with some embodiments presented herein. First input data set 601 may include data fields or columns for name, service type (e.g., 5G or 4G network service), and age. Second input data set 603 may include data fields or columns for name and network usage. The hybrid linkage definition may target consolidated data for network usage of 5G subscribers. Since non-5G subscribers cannot produce 5G network usage, constraint 605 may be specified in the hybrid linkage definition to generate data record pairs 607 only for data records of first input data set 601 that specify a 5G service type. Accordingly, the merging of the data sets 601 and 603 may yield a constrained search space that excludes data records from first input data set 601 containing data for a non-5G subscriber. The constrained search space reduces the total number of data records that are evaluated for matches, thereby reducing the overall time for hybrid linkage system 100 to generated the linkages and consolidated data.

With reference back to FIG. 5, process 500 may include defining (at 508) a linkage model for the merged data set. The linkage model may include an executable query, function, and/or expression that evaluates the data from the merged data records according to the matching (e.g., exact, Levenshtein, Jaro-Winkler, Jaccard, Needleman Wunsch, Trigram, etc.) specified in the hybrid linkage definition on specified data fields or columns, the logic (e.g., Boolean logic or fuzzy logic) and/or thresholds for classifying the match results into Boolean values or linguistic terms, the linkage type (e.g., regular linkage or fuzzy linkage) for converting the match scores and/or linguistic terms from each evaluated data field or column into a total linkage score, and/or other parameters within the hybrid linkage definition that control the hybrid linkage.

Process 500 may include linking (at 510) data record pairs from the merged data set by performing the linkage model matching operations. In some embodiments, linking (at 510) the data record pairs may include generating one or more match scores for each data field or column of a data record pair based on the exact, probabilistic, approximate, fuzzy, and/or other matching specified in the linkage model for that data field or column, using Boolean logic to convert the match scores into Boolean values that express a binary linkage, and/or using fuzzy logic to convert the match scores into linguistic terms that express possibilistic linkages and/or linkages of varying degrees. The linking (at 510) may be performed in multiple iterations. Each iteration may evaluate whether a different data field or column from a data record pair is a match as determined by the matching algorithm and logic specified for that data field or column, and may compute a weight and/or score based on the logic (e.g., Boolean logic or fuzzy logic) specified for determining that match.

Process 500 may include determining (at 512) a total linkage score for each linked data record pair. In some embodiments, a weight vector (for the corresponding data fields or columns) may be assigned to a data record pair using FAHP and/or other techniques. The weight vector may include fuzzy weights (e.g., triangular fuzzy numbers) or corresponding defuzzified crisp values that quantify the relevance of the linguistic terms in relation to different linked data fields or columns of the data record pair. The total linkage score may be based on the weight vector (“W”) and the score vector (“S”) associated with each data field or column within the linked data record pair, and the computation of the total linkage score may differ according to the logic type and/or linkage type specified for those fields or columns in the linkage model definition.

In some embodiments, the total linkage score may be computed as the dot product of the weight vector (“W”) and the score vector (“S”) (e.g., W*S) when the linkage type for the linked data pair is “regular” and when the logic type is “fuzzy”. In some such embodiments, the fuzzy weights of the weight vector may first be converted to crisp weights before computing the dot product. Converting from the fuzzy weights to the crisp weights may include defuzzifying the fuzzy weights for each linguistic term that is used to describe the relevance and/or importance of each linked data field or column.

In some embodiments, the total linkage score may be computed using fuzzy linkage and fuzzy aggregation when the linkage type for the linked data pair is “fuzzy” and when the logic type is “fuzzy”. The fuzzy linkage may include extracting the a-cuts from the triangular fuzzy numbers and the score ranges of the linked data fields or columns. The fuzzy aggregation may include i) generating weighted match scores for the linked data fields or columns using their defuzzified weights and match scores and ii) computing a fuzzy weighted average of the a-cuts of the fuzzy weighs and fuzzy match scores. Fuzzy sets for the linguistic terms may then be defined using sub-intervals from the spread (e.g., range) and distribution of the weighted match scores of the respective linked columns as well as from the computed interval of the total linkage score represented by the triangular fuzzy number. The fuzzy sets on the various match and linkage scores may be used to define a fuzzy controller with a set of fuzzy rules. The fuzzy controller may use fuzzy inference based on the set of fuzzy rules to generate a defuzzified total linkage score for each linked data pair from the weight matched scores of the linked data fields or columns.

Process 500 may include performing (at 514) fuzzy clustering (e.g., fuzzy c-means clustering) using the total linkage scores to classify the matches amongst the linked data pairs. The fuzzy clustering may define a number of clusters, and may assign a membership score for each linked data pair to each of the clusters. The membership score may represent the degree to which the linked data pair belongs to a cluster and/or the degree to which the linked data pair is deemed a match for the classification associated with the cluster. For instance, the fuzzy clustering may define three clusters with classifications of “matches”, “possible matches”, and “non-matches”, and may assign a membership value of 0.4 to the “matches” cluster for a linked data pair with a particular total linkage score, a membership value of 0.6 to the “possible matches” cluster for the linked data pair, and a membership value of 0.2 to the “non-matches” cluster for the linked data pair. Based on the highest degrees of membership to the “possible matches” cluster, the fuzzy clustering may classify the linked data pair as a possible match.

With reference back to FIG. 2, the matches and possible matches may indicate a high concentration of UEs at a first side of RAN 209 that use much of the RF resources allocated to that first side and with a large allocation of RF resources on an opposite of RAN 209 remaining unused. In response to the matching, hybrid matching system 100 may modify directionality, beam width, antenna power, and/or other aspects of the beam configuration for the base station in RAN 209 so that the unused RF resources are shifted to the direction or side of RAN 209 experiencing heavy usage (e.g., the first side).

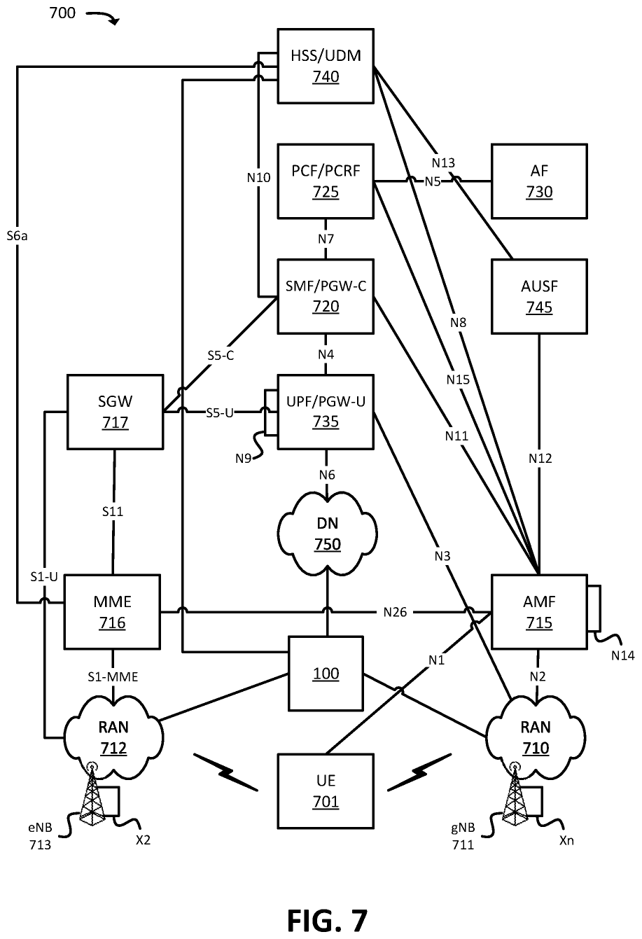

FIG. 7 illustrates an example environment 700, in which one or more embodiments may be implemented. In some embodiments, environment 700 may correspond to a 5G network, and/or may include elements of a 5G network. In some embodiments, environment 700 may correspond to a 5G Non-Standalone (“NSA”) architecture, in which a 5G radio access technology (“RAT”) may be used in conjunction with one or more other RATs (e.g., an LTE RAT), and/or in which elements of a 5G core network may be implemented by, may be communicatively coupled with, and/or may include elements of another type of core network (e.g., an evolved packet core (“EPC”)). As shown, environment 700 may include UE 701, RAN 710 (which may include one or more Next Generation Node Bs (“gNBs”) 711), RAN 712 (which may include one or more evolved Node Bs (“eNBs”) 713), and various network functions such as Access and Mobility Management Function (“AMF”) 715, Mobility Management Entity (“MIME”) 716, Serving Gateway (“SGW”) 717, Session Management Function (“SMF”)/Packet Data Network (“PDN”) Gateway (“PGW”)-Control plane function (“PGW-C”) 720, Policy Control Function (“PCF”)/Policy Charging and Rules Function (“PCRF”) 725, Application Function (“AF”) 730, User Plane Function (“UPF”)/PGW-User plane function (“PGW-U”) 735, Home Subscriber Server (“HSS”)/Unified Data Management (“UDM”) 740, and Authentication Server Function (“AUSF”) 745. Environment 700 may also include one or more networks, such as Data Network (“DN”) 750. Environment 700 may include one or more additional devices or systems communicatively coupled to one or more networks (e.g., DN 750), such as hybrid linkage system 100.

The example shown in FIG. 7 illustrates one instance of each network component or function (e.g., one instance of SMF/PGW-C 720, PCF/PCRF 725, UPF/PGW-U 735, HSS/UDM 740, and/or AUSF 745). In practice, environment 700 may include multiple instances of such components or functions. For example, in some embodiments, environment 700 may include multiple “slices” of a core network, where each slice includes a discrete set of network functions (e.g., one slice may include a first instance of SMF/PGW-C 720, PCF/PCRF 725, UPF/PGW-U 735, HSS/UDM 740, and/or AUSF 745, while another slice may include a second instance of SMF/PGW-C 720, PCF/PCRF 725, UPF/PGW-U 735, HSS/UDM 740, and/or AUSF 745). The different slices may provide differentiated levels of service, such as service in accordance with different Quality of Service (“QoS”) parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. Alternatively, or additionally, one or more of the devices of environment 700 may perform one or more network functions described as being performed by another one or more of the devices of environment 700. Devices of environment 700 may interconnect with each other and/or other devices via wired connections, wireless connections, or a combination of wired and wireless connections. In some implementations, one or more devices of environment 700 may be physically integrated in, and/or may be physically attached to, one or more other devices of environment 700.

UE 701 may include a computation and communication device, such as a wireless mobile communication device that is capable of communicating with RAN 710, RAN 712, and/or DN 750. UE 701 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Machine-to-Machine (“M2M”) device, or another type of mobile computation and communication device. UE 701 may send traffic to and/or receive traffic (e.g., user plane traffic) from DN 750 via RAN 710, RAN 712, and/or UPF/PGW-U 735.

RAN 710 may be, or may include, a 5G RAN that includes one or more base stations (e.g., one or more gNBs 711), via which UE 701 may communicate with one or more other elements of environment 700. UE 701 may communicate with RAN 710 via an air interface (e.g., as provided by gNB 711). For instance, RAN 710 may receive traffic (e.g., voice call traffic, data traffic, messaging traffic, signaling traffic, etc.) from UE 701 via the air interface, and may communicate the traffic to UPF/PGW-U 735, and/or one or more other devices or networks. Similarly, RAN 710 may receive traffic intended for UE 701 (e.g., from UPF/PGW-U 735, AMF 715, and/or one or more other devices or networks) and may communicate the traffic to UE 701 via the air interface.

RAN 712 may be, or may include, a LTE RAN that includes one or more base stations (e.g., one or more eNBs 713), via which UE 701 may communicate with one or more other elements of environment 700. UE 701 may communicate with RAN 712 via an air interface (e.g., as provided by eNB 713). For instance, RAN 710 may receive traffic (e.g., voice call traffic, data traffic, messaging traffic, signaling traffic, etc.) from UE 701 via the air interface, and may communicate the traffic to UPF/PGW-U 735, and/or one or more other devices or networks. Similarly, RAN 710 may receive traffic intended for UE 701 (e.g., from UPF/PGW-U 735, SGW 717, and/or one or more other devices or networks) and may communicate the traffic to UE 701 via the air interface.

AMF 715 may include one or more devices, systems, Virtualized Network Functions (“VNFs”), Cloud-Native Network Functions (“CNFs”), etc., that perform operations to register UE 701 with the 5G network, to establish bearer channels associated with a session with UE 701, to hand off UE 701 from the 5G network to another network, to hand off UE 701 from the other network to the 5G network, manage mobility of UE 701 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, CNFs, etc., that perform operations to register UE 701 with the EPC, to establish bearer channels associated with a session with UE 701, to hand off UE 701 from the EPC to another network, to hand off UE 701 from another network to the EPC, manage mobility of UE 701 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 701. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 701, from DN 750, and may forward the user plane data toward UE 701 (e.g., via RAN 710, SMF/PGW-C 720, and/or one or more other devices). In some embodiments, multiple UPFs 735 may be deployed (e.g., in different geographical locations), and the delivery of content to UE 701 may be coordinated via the N9 interface (e.g., as denoted in FIG. 7 by the line marked “N9” originating and terminating at UPF/PGW-U 735). Similarly, UPF/PGW-U 735 may receive traffic from UE 701 (e.g., via RAN 710, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

HSS/UDM 740 and AUSF 745 may include one or more devices, systems, VNFs, CNFs, etc., that manage, update, and/or store, in one or more memory devices associated with AUSF 745 and/or HSS/UDM 740, profile information associated with a subscriber. AUSF 745 and/or HSS/UDM 740 may perform authentication, authorization, and/or accounting operations associated with the subscriber and/or a communication session with UE 701.

DN 750 may include one or more wired and/or wireless networks. For example, DN 750 may include an Internet Protocol IP-based PDN, a wide area network (“WAN”) such as the Internet, a private enterprise network, and/or one or more other networks. UE 701 may communicate, through DN 750, with data servers, other UEs 701, and/or to other servers or applications that are coupled to DN 750. DN 750 may be connected to one or more other networks, such as a public switched telephone network (“PSTN”), a public land mobile network (“PLMN”), and/or another network. DN 750 may be connected to one or more devices, such as content providers, applications, web servers, and/or other devices, with which UE 701 may communicate.

In some embodiments, hybrid linkage system 100 may be used to deploy, configure, and run one or more of RAN 710, RAN 712, AMF 715, MME 716, SGW 717, SMF/PGW-C 720, PCF/PCRF 725, AF 730, UPF/PGW-U 735, HSS/UDM 740, AUSF 745, and/or other network functions of environment 700 using the consolidated data from different data sources containing data about the different network elements. The data sources may be located in DN 750.

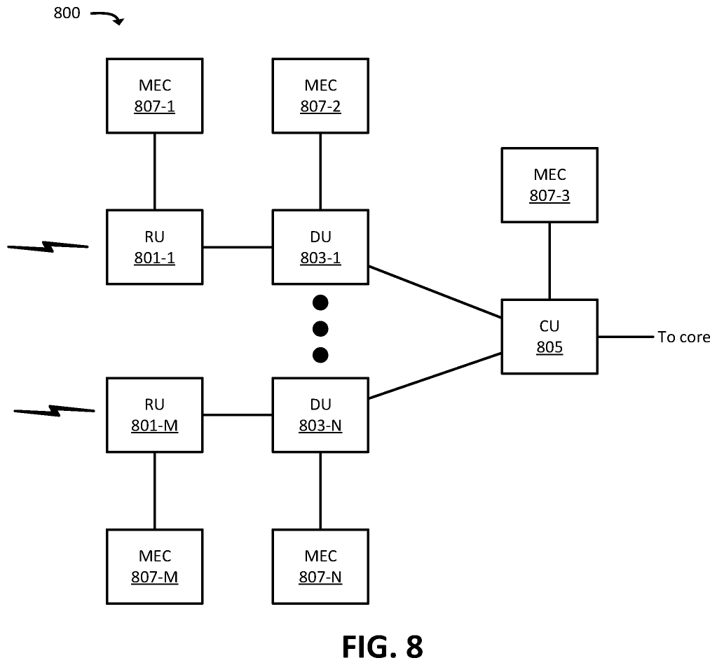

FIG. 8 illustrates an example Distributed Unit (“DU”) network 800, which may be included in and/or implemented by one or more RANs (e.g., RAN 710, RAN 712, or some other RAN). In some embodiments, a particular RAN may include one DU network 800. In some embodiments, a particular RAN may include multiple DU networks 800. In some embodiments, DU network 800 may correspond to a particular gNB 711 of a 5G RAN (e.g., RAN 710). In some embodiments, DU network 800 may correspond to multiple gNBs 711. In some embodiments, DU network 800 may correspond to one or more other types of base stations of one or more other types of RANs. As shown, DU network 800 may include Central Unit (“CU”) 805, one or more Distributed Units (“DUs”) 803-1 through 803-N (referred to individually as “DU 803,” or collectively as “DUs 803”), and one or more Radio Units (“RUs”) 801-1 through 801-M (referred to individually as “RU 801,” or collectively as “RUs 801”).

CU 805 may communicate with a core of a wireless network (e.g., may communicate with one or more of the devices or systems described above with respect to FIG. 7, such as AMF 715 and/or UPF/PGW-U 735). In the uplink direction (e.g., for traffic from UEs 701 to a core network), CU 805 may aggregate traffic from DUs 803, and forward the aggregated traffic to the core network. In some embodiments, CU 805 may receive traffic according to a given protocol (e.g., Radio Link Control (“RLC”)) from DUs 803, and may perform higher-layer processing (e.g., may aggregate/process RLC packets and generate Packet Data Convergence Protocol (“PDCP”) packets based on the RLC packets) on the traffic received from DUs 803.

In accordance with some embodiments, CU 805 may receive downlink traffic (e.g., traffic from the core network) for a particular UE 701, and may determine which DU(s) 803 should receive the downlink traffic. DU 803 may include one or more devices that transmit traffic between a core network (e.g., via CU 805) and UE 701 (e.g., via a respective RU 801). DU 803 may, for example, receive traffic from RU 801 at a first layer (e.g., physical (“PHY”) layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 701.

RU 801 may include hardware circuitry (e.g., one or more RF transceivers, antennas, radios, and/or other suitable hardware) to communicate wirelessly (e.g., via an RF interface) with one or more UEs 701, one or more other DUs 803 (e.g., via RUs 801 associated with DUs 803), and/or any other suitable type of device. In the uplink direction, RU 801 may receive traffic from UE 701 and/or another DU 803 via the RF interface and may provide the traffic to DU 803. In the downlink direction, RU 801 may receive traffic from DU 803, and may provide the traffic to UE 701 and/or another DU 803.

RUs 801 may, in some embodiments, be communicatively coupled to one or more Multi-Access/Mobile Edge Computing (“MEC”) devices, referred to sometimes herein simply as “MECs” 807. For example, RU 801-1 may be communicatively coupled to MEC 807-1, RU 801-M may be communicatively coupled to MEC 807-M, DU 803-1 may be communicatively coupled to MEC 807-2, DU 803-N may be communicatively coupled to MEC 807-N, CU 805 may be communicatively coupled to MEC 807-3, and so on. MECs 807 may include hardware resources (e.g., configurable or provision-able hardware resources) that may be configured to provide services and/or otherwise process traffic to and/or from UE 701, via a respective RU 801.

For example, RU 801-1 may route some traffic, from UE 701, to MEC 807-1 instead of to a core network (e.g., via DU 803 and CU 805). MEC 807-1 may process the traffic, perform one or more computations based on the received traffic, and may provide traffic to UE 701 via RU 801-1. In this manner, ultra-low latency services may be provided to UE 701, as traffic does not need to traverse DU 803, CU 805, and an intervening backhaul network between DU network 800 and the core network. In some embodiments, MEC 807 may include, and/or may implement, some or all of the functionality described above with respect to hybrid linkage system 100.

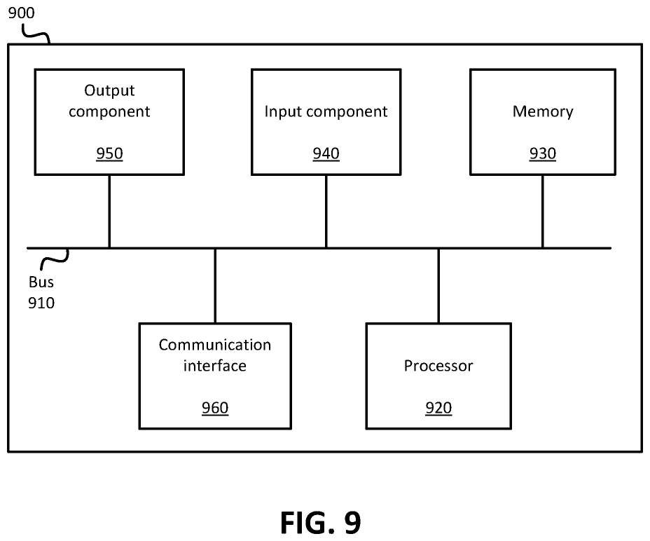

FIG. 9 illustrates example components of device 900. One or more of the devices described above may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. In some embodiments, processor 920 may be or may include one or more hardware processors. Memory 930 may include any type of dynamic storage device that may store information and instructions for execution by processor 920, and/or any type of non-volatile storage device that may store information for use by processor 920.

Input component 940 may include a mechanism that permits an operator to input information to device 900 and/or other receives or detects input from a source external to 940, such as a touchpad, a touchscreen, a keyboard, a keypad, a button, a switch, a microphone or other audio input component, etc. In some embodiments, input component 940 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-3, 5, and 6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive a plurality of data records from a plurality of data sources, each data record of the plurality of data records comprising values for a plurality of data fields;
generate a plurality of data record pairs by merging data records from a first data source with data records from a second data source;
compute a first score based on results of a first fuzzy match between a first data field from a first data record of a particular data record pair and a first data field from a second data record of that particular data record pair;
compute a second score based on results of a second fuzzy match between a second data field from the first data record and a second data field from the second data record;
classify the particular data record pair with a weight from a first linguistic term in a plurality of non-binary linguistic terms based on the first score, and with a weight from a second linguistic term in the plurality of non-binary linguistic terms based on the second score; and
execute an action that uses consolidated data from the first data record and the second data record in response to the first linguistic term for the first match score and the second linguistic term for the second match score, evaluating to a match between the first data record and the second data record.

2. The device of claim 1, wherein performing the action comprises:
selecting content from a plurality of different content based on the consolidated data; and
presenting the content in response to a query with a value that matches a value within a data field of the first data record or a data field of the second data record.

3. The device of claim 1, wherein the one or more processors are further configured to:
modify an allocation of Radio Frequency (“RF”) resources at a network component, that provides one or more user equipment (“UEs”) access to network services, in response to executing the action.

4. The device of claim 1, wherein the one or more processors are further configured to:
assign fuzzy weights to each of the first linguistic term and the second linguistic term using fuzzy logic; and
compute a linkage score for the particular data record pair based on the first score, the second score, and the corresponding fuzzy weights.

5. The device of claim 4, wherein the one or more processors are further configured to:
define different membership of the particular data record pair into two or more different clusters based on the linkage score; and
determine a degree with which the first data record matches to the second data record based on the different membership of the particular data record pair into the two or more different clusters.

6. The device of claim 1, wherein the one or more processors are further configured to:
generate triangular fuzzy numbers by evaluating the first linguistic term and the second linguistic term with fuzzy logic; and
categorize the particular data record pair as a true match, possible match, or no match by combining the triangular fuzzy numbers, that represent weights of the first and second linguistic terms, and match scores of the data fields to generate a total linkage score and then clustering the scores from all record pairs.

7. The device of claim 1, wherein the one or more processors are further configured to:
compute a third score based on results of an exact match between a third data field from the first data record and a third data field from the second data record; and
determine a linkage between the first data record and the second data record by using fuzzy logic on the first score and the second score and Boolean logic on the third score to evaluate a degree with which the first data record matches to the second data record.

8. A non-transitory computer-readable medium, storing a plurality of processor-executable instructions to:
receive a plurality of data records from a plurality of data sources, each data record of the plurality of data records comprising values for a plurality of data fields;
generate a plurality of data record pairs by merging data records from a first data source with data records from a second data source;
compute a first score based on results of a first fuzzy match between a first data field from a first data record of a particular data record pair and a first data field from a second data record of that particular data record pair;
compute a second score based on results of a second fuzzy match between a second data field from the first data record and a second data field from the second data record;
classify the particular data record pair with a weight from a first linguistic term in a plurality of non-binary linguistic terms based on the first score, and with a weight from a second linguistic term in the plurality of non-binary linguistic terms based on the second score; and
execute an action that uses consolidated data from the first data record and the second data record in response to the first linguistic term for the first match score and the second linguistic term for the second match score, evaluating to a match between the first data record and the second data record.

9. The non-transitory computer-readable medium of claim 8, wherein performing the action comprises:
selecting content from a plurality of different content based on the consolidated data; and
presenting the content in response to a query with a value that matches a value within a data field of the first data record or a data field of the second data record.

10. The non-transitory computer-readable medium of claim 8, wherein the plurality of processor-executable instructions further include processor-executable instructions to:
modify an allocation of Radio Frequency (“RF”) resources at a network component, that provides one or more user equipment (“UEs”) access to network services, in response to executing the action.

11. The non-transitory computer-readable medium of claim 8, wherein the plurality of processor-executable instructions further include processor-executable instructions to:
assign fuzzy weights to each of the first linguistic term and the second linguistic term using fuzzy logic; and
compute a linkage score for the particular data record pair based on the first score, the second score, and the corresponding fuzzy weights.

12. The non-transitory computer-readable medium of claim 11, wherein the plurality of processor-executable instructions further include processor-executable instructions to:
define different membership of the particular data record pair into two or more different clusters based on the linkage score; and
determine a degree with which the first data record matches to the second data record based on the different membership of the particular data record pair into the two or more different clusters.

13. The non-transitory computer-readable medium of claim 8, wherein the plurality of processor-executable instructions further include processor-executable instructions to:
generate triangular fuzzy numbers by evaluating the first linguistic term and the second linguistic term with fuzzy logic; and
categorize the particular data record pair as a true match, possible match, or no match by combining the triangular fuzzy numbers, that represent weights of the first and second linguistic terms, and match scores of the data fields to generate a total linkage score and then clustering the scores from all record pairs.

14. The non-transitory computer-readable medium of claim 8, wherein the plurality of processor-executable instructions further include processor-executable instructions to:
compute a third score based on results of an exact match between a third data field from the first data record and a third data field from the second data record; and
determine a linkage between the first data record and the second data record by using fuzzy logic on the first score and the second score and Boolean logic on the third score to evaluate a degree with which the first data record matches to the second data record.

15. A method, comprising:
receiving a plurality of data records from a plurality of data sources, each data record of the plurality of data records comprising values for a plurality of data fields;
generating a plurality of data record pairs by merging data records from a first data source with data records from a second data source;
computing a first score based on results of a first fuzzy match between a first data field from a first data record of a particular data record pair and a first data field from a second data record of that particular data record pair;
computing a second score based on results of a second fuzzy match between a second data field from the first data record and a second data field from the second data record;
classifying the particular data record pair with a weight from a first linguistic term in a plurality of non-binary linguistic terms based on the first score, and with a weight from a second linguistic term in the plurality of non-binary linguistic terms based on the second score; and
executing an action that uses consolidated data from the first data record and the second data record in response to the first linguistic term for the first match score and the second linguistic term for the second match score, evaluating to a match between the first data record and the second data record.

16. The method of claim 15, wherein performing the action comprises:
selecting content from a plurality of different content based on the consolidated data; and
presenting the content in response to a query with a value that matches a value within a data field of the first data record or a data field of the second data record.

17. The method of claim 15, further comprising:
modify an allocation of Radio Frequency (“RF”) resources at a network component, that provides one or more user equipment (“UEs”) access to network services, in response to executing the action.

18. The method of claim 15, further comprising:
assigning fuzzy weights to each of the first linguistic term and the second linguistic term using fuzzy logic; and
computing a linkage score for the particular data record pair based on the first score, the second score, and the corresponding fuzzy weights.

19. The method of claim 18, further comprising:
defining different membership of the particular data record pair into two or more different clusters based on the linkage score; and
determining a degree with which the first data record matches to the second data record based on the different membership of the particular data record pair into the two or more different clusters.

20. The method of claim 15, further comprising:
generating a triangular fuzzy numbers by evaluating the first linguistic term and the second linguistic term with fuzzy logic; and
categorizing the particular data record pair as a true match, possible match, or no match by combining the triangular fuzzy numbers, that represent weights of the first and second linguistic terms, and match scores of the data fields to generate a total linkage score and then clustering the scores from all record pairs.
